(19) United States
(12) Patent Application Publication
(10) Pub. No.: US 2009/0000457 A1
(43) Pub. Date: Jan. 1, 2009

(54) UNIVERSAL, PORTABLE ITEM SUPPORT

(76) Inventor: Jim Dunlop, Benicia, CA (US)

Correspondence Address: WEST & ASSOCIATES, A PC, 2815 MITCHELL DRIVE, SUITE 209, WALNUT CREEK, CA, 94598, US

(21) Appl. No.: 12/147,460

(22) Filed: Jun. 26, 2008

Related U.S. Application Data
(63) Continuation-in-part of application No. 11/585,495, filed on Oct. 24, 2006.

(51) Int. Cl. G10D 3/00

(52) U.S. Cl. 84/329

(57) ABSTRACT

A holder, comprising a first power-assisted suction device for selectively coupling with a first item, a second power-assisted suction device for selectively coupling with a second item, a clamp ball attached to each of the first and second power-assisted suction devices and a clamp configured such that the clamp can selectively engages each of the clamp balls and allows relative adjustment of the first power-assisted suction device and the second power-assisted suction device.

### CONTINUITY/CLAIM OF PRIORITY

This application is a continuation-in-part of co-pending U.S. patent application Ser. No. 11/585,495, filed Oct. 24, 2006 by Jim Dunlop, the complete contents of which is hereby incorporated herein by reference.

### BACKGROUND

1. Field of the Invention

The present invention relates to musical instruments and in particular to methods, systems, and devices for securing items on an instrument where an artist can view it during a musical performance.

2. Related Art

Sheet music is rather awkward to hold and read while trying to play a musical instrument like a guitar. But being able to read the music while playing the instrument is a critical necessity. Sheet music stands are very familiar to most people, but such take up floor space, are top heavy, easily knocked over, and restrict the movements of the performer.

Attempts have been made to attach holders to guitars before, but the kind that clamp-on are heavy and can mar the instrument, and other devices that use suction cups don't really attach in a satisfactory fashion or remain in place for an acceptable period of time. Often the surfaces of the guitar are a little porous, and defeat any suction device applied. Other suction devices are cheap and flimsy, and just don't apply a high enough vacuum to really keep the attachment firmly in place. See, for example, U.S. Pat. No. 3,948,476 to Shiniti Kunyosi.

### SUMMARY OF THE INVENTION

Briefly, a sheet music holder embodiment of the present invention comprises a golpe board of non-porous material for gluing onto a guitar body should the surface be porous, a suction device that is power-assisted for maximum consistent suction, a clamp with a single or plural tightening nut(s), and a sheet tray to hold the sheet music and/or other optional attachments. The power-assisted suction device allows a user to easily create a strong vacuum attachment that will last for hours.

The non-porous golpe board is included where the guitar body has a porous surface that would otherwise frustrate the suction attachment. In some embodiments, a substantially non-porous or non-porous mounting board, which is not attached to the instrument, can be included, such that the suction mechanism and associated sheet music tray can be selectively coupled with the mounting board and the mounting board can be located in any convenient location. The double-ball and socket clamp and arm allows a variety of positioning possibilities for the user to best read the sheet music in the tray.

An advantage of the present invention is that a sheet music holder is provided that is easy to use.

Another advantage of the present invention is that a sheet music holder is provided that will not mar a musical instrument even after repeated uses.

A further advantage of the present invention is that a sheet music holder is provided that will stay fastened for many hours and not slip off accidentally thanks to a twist-lock action in the power-assisted suction device.

These and other objects and advantages of the present invention will no doubt become obvious to those of ordinary skill in the art after having read the following detailed description of the preferred embodiments which are illustrated in the various drawing figures.

### BRIEF DESCRIPTION OF THE DRAWINGS

FIG. 1 is a perspective diagram of a sheet music holder embodiment of the present invention that is attached, as an example, to an acoustic guitar;

FIG. 2 is an exploded assembly diagram of the sheet music holder of FIG. 1 showing how the pieces come together and attach to the acoustic guitar;

FIG. 3 is a perspective view diagram of a decorative 10 type of sheet music tray that could be included in the holders illustrated in FIGS. 1 and 2.

FIG. 4a depicts a plan view of a mounting board that can be selectively coupled with the sheet music tray via a suction mechanism.

FIG. 4b depicts an elevation view of the sheet music tray coupled with the mounting board via the suction mechanism.

FIG. 5 depicts an alternate embodiment of the apparatus depicted in FIG. 1.

FIG. 6 depicts an embodiment of the apparatus of FIG. 5 in use.

FIGS. 7a-7c depicts an alternate embodiments of the attachment device depicted in FIGS. 5 and 6.

FIG. 8 depicts a kit comprising selected elements as depicted in FIGS. 1-7.

### DETAILED DESCRIPTION

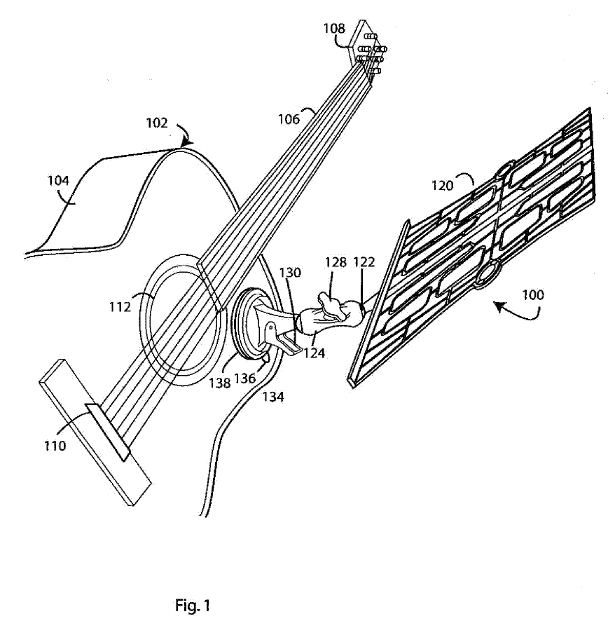

FIG. 1 represents a sheet music holder embodiment of the present invention, and is referred to herein by the general reference numeral 100. The sheet music holder 100 attaches, for example, to an acoustic guitar 102 comprising a body 104, a fret board 106, a key head 108, a bridge 110, and a sounding hole 112. While FIG. 1 depicts use of the sheet music holder 100 being used in connection with an acoustic guitar 102, in alternate embodiments, the sheet music holder 100 can be used in connection with any item, instrumental or otherwise.

In the embodiment shown in FIG. 1, the sheet music holder 100 comprises a sheet holding tray 120 with a tray clamp ball 122 joined by a clamp assembly 124 to a base clamp ball 126 and tightened with a handle 128. In the embodiment shown in FIG. 1, a power-assisted suction base can be comprised of an activation lever 130 inside a base housing 132 that draws the base tight onto the guitar 102. In some embodiments, the suction base can include a release tab 134 that allows a quick release of suction cup 136 from a non-porous or substantially non-porous surface.

In some embodiments, a substantially non-porous or a non-porous surfaced golpe board 138 can be used if the instrument itself has a porous surface. In the embodiment depicted in FIG. 1, the clamp assembly 124 allows a user to position the sheet holding tray 120 in substantially any convenient position relative to the instrument and/or golpe board 138 and or mounting surface. In operation, the tray clamp ball 122 and base clamp ball 126 can be loosely coupled with the clamp assembly 124, the sheet holding tray 120 can be positioned as desired, and then the clamp can be fully tightened to fix geometric relation between the mounting surface and the sheet holding tray 120.

In some embodiments, the golpe board 138 can be attached to the body 104, e.g., with adhesive or via any other known and/or convenient apparatus, mechanism or compound, and provides a high quality, non-porous or substantially non-porous surface for vacuum cup attachment. Traditionally, golpe boards are attached to guitars for flamenco music performances where the guitar body is subject to heavy tapping that could damage the soft wood and finishes. If the guitar body 104 already has a suitable surface, the golpe board 138 may not be needed and can be omitted. In alternate embodiments, the golpe board 138 can be comprised of any known and/or convenient material and can have any known and/or convenient shape and can be attached to any convenient manner to the body. In still further alternate embodiments, the golpe board 138 may not be a traditional golpe board, but can be comprised of any known and/or convenient material and can have any known and/or convenient shape and can be attached to any convenient manner to any surface of any item, instrument and/or object.

In some embodiments, the suction base and clamp assembly may be a National Products, Inc., type RAM-B-101-2241U, RAM-MOUNT with twist lock cup. The twist lock power-assisted suction device is described by Jeffrey Carnevali in U.S. Pat. No. 6,666,420, issued Dec. 23, 2003, the complete contents of which is incorporated herein by reference. However, in alternate embodiments, any known and/or convenient non-power-assisted and/or power-assisted suction mechanism can be used.

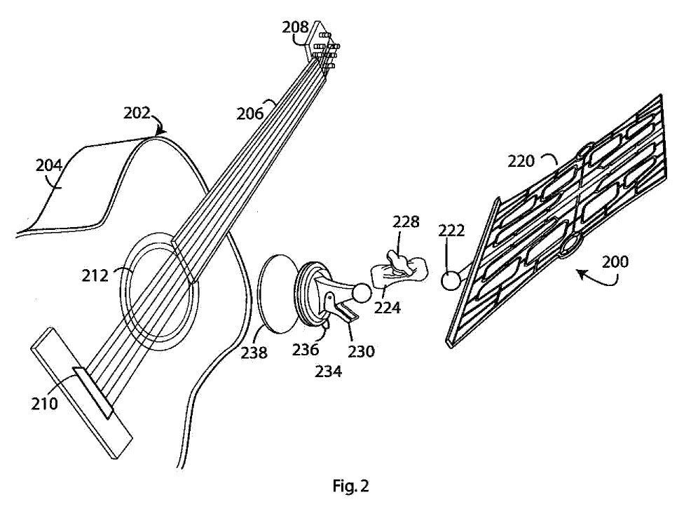

FIG. 2 represents a sheet music holder assembly, and is referred to herein by the general reference numeral 200. The sheet music holder 200 can attach to a musical instrument or nearby surface. If the musical instrument or nearby surface is an acoustic guitar 202, such can comprise a body 204, a fret board 206, a key head 208, a bridge 210, and a sounding hole 212. In some embodiments, the sheet music holder 200 can comprise a sheet holding tray 220 coupled with a tray clamp ball 222. In operation, a pair of clamp shells 224 and 225, with ball sockets, can capture tray clamp ball 222 and a similar base clamp ball 226. They can then be simultaneously tightened around both balls 222 and 226 with a single T-handle tightening nut 228 on a bolt and/or via any other known and/or convenient mechanism. In alternate embodiments, each end of the clamp shells can be individually controlled to selectively engage each of the balls 222 226 in any known, convenient and/or desired manner. In some embodiments, at least a portion of the interior surface of at least one of the clamp shells 224 225 can include an elastomeric surface 238 having a desired coefficient of kinetic and/or static friction relative to one or more of the balls 222 226. In alternate embodiments, at least a portion of the exterior surface of one or more of the balls 222 226 can include an elastomeric surface 240 having a desired coefficient of kinetic and/or static friction relative to at least one of the interior surfaces of the at least one portion of one of the clamp shells 224 225.

In the embodiment depicted in FIG. 2, a suction base can have an activation lever 230 operable coupled with a base housing 232 that draws the base tight onto a non-porous and/or substantially non-porous surface. In some embodiments, a release tab 234 allows a quick release of suction cup 236, e.g., against a golpe board 238 that was coupled with the guitar body 204. The clamp assembly 224 allows a user to position the sheet holding tray 220 relative to the instruction or nearby surface in any known and/or convenient geometric relation.

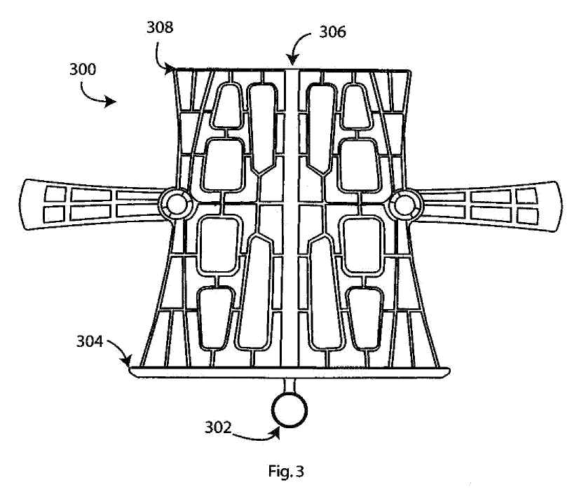

FIG. 3 shows a music sheet tray 300 with a particular 25 decorative design that provides maximum surface area and strength with a minimum of weight. Of course, other designs could be used. The tray 300 comprises a tray clamp ball 302 to fit into a clamp as shown in FIGS. 1 and 2. A lip 304 provides a bottom support for sheets of paper, e.g., sheet music. The tray clamp ball 302 and base clamp ball are preferably about the same size diameter. A back 308 would be visible to an audience, and a backbone 306 provides added strength such as would be needed in a plastic injection molded implementation.

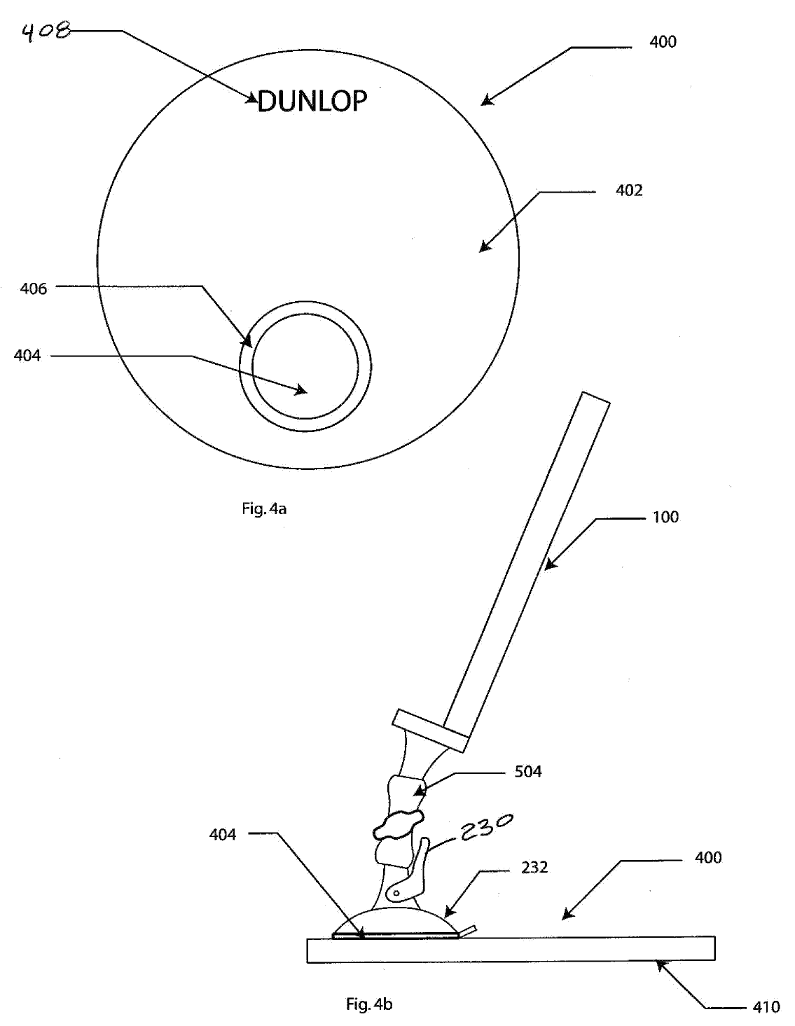

FIG. 4a depicts a mounting board 400 that can be used in conjunction with the sheet music holder 100. In the embodiment shown in FIG. 4a, the mounting board 400 is comprised of a first region 402 and a second region 404 and a transition region 406. In the embodiment shown in FIG. 4a, the first region 402 can have any known and/or convenient texture and/or porosity and/or image and/or geometric properties. In some embodiments, the first region can be substantially planar and can be comprised of a substantially non-porous material. However, in alternate embodiments, the first region can have a non-uniform surface. In still further alternate embodiments, the first region 402 can include any convenient decoration and/or image 408.

In the embodiment shown in FIG. 4a, the second region can be substantially planar and can be comprised of a substantially non-porous material and/or any material capable of substantially maintaining a vacuum bond with the suction cup of the sheet music holder 100. In some embodiments, the first region 402 and second region 404 can be comprised of the same and/or similar material and can be of unitary construction. However, in alternate embodiments, the first region 402 and the second region 404 can be comprised of different materials and can be coupled with each other.

In the embodiment shown in FIG. 4a, the mounting board 400 can include a transition region 406. In the embodiment shown in FIG. 4a, the transition region can server to, at least partially, separate the first region 402 and the second region 404. In some embodiments, the first region 402, second region 404 and the transition region 406 can be comprised of the same material and can be of unitary construction. In alternate embodiments, the transition region 406 can be comprised of any known and/or convenient material and/or can be comprised of the same material as the first region 402 and/or the second region 404. In some embodiments, the transition region 406 can bear any known and or convenient geometric relation to the first region 402 and the second region 404.

In some embodiments, the underside 410 of the mounting board 400 can have any known and/or convenient geometry properties. In some embodiments, the underside 410 of the mounting board 400 can include a temporary bonding material such that the underside 410 of the mounting board 400 can be selectively coupled with any known and/or convenient surface and/or material. In some embodiments, the underside 410 of the mounting board 410 can include a surface that has a substantially high coefficient of static and/or kinetic friction relative to any selected material.

FIG. 4b depicts an embodiment of the mounting board 400 depicted in FIG. 4a in use with the sheet music holder 100. In the embodiment shown in FIG. 4b, the mounting board 400 is substantially planar and the sheet music holder 100 is selectively coupled with the second region 404 of the mounting board 400 via the suction base. In some embodiments, the mounting board 400 can have any known and/or convenient geometric and/or inertial and/or section modulus properties such that when the mounting board 400 and the sheet music holder 100 are coupled that the combination is statically and/or dynamically stable.

In some embodiments, in operation, the sheet music holder 100 can be used with or without the mounting board 400 and can, in some embodiments, be used by a computer operator or typist to support paper, documents, books and/or other items.

In some embodiments, in operation, the sheet music holder 100 can be used with or without the mounting board 400 and can, in some embodiments, be used by a chef and/or to support recipes, paper, documents, books and/or other items.

In some embodiments, in operation, the sheet music holder 100 can be used with or without the mounting board 400 and can be supported on any convenient surface, such as, over a table cloth, on a couch, on a floor and/or any other surface capable of supporting the base and/or capable of being attached by the suction mechanism.

In some embodiments, in some embodiments, the sheet music holder 100 can be removably mounted, via the suction mechanism, directly on an instrument, such as, a guitar, bass, ukulele, keyboard and/or any other instrument having a non-porous and/or substantially non-porous surface. In alternate embodiments, the sheet music holder 100 can be removably mounted, via the suction mechanism, directly on an instrument, such as, a guitar, bass, ukulele, keyboard and/or any other instrument which has been coupled and/or removably coupled with a non-porous and/or substantially non-porous surface.

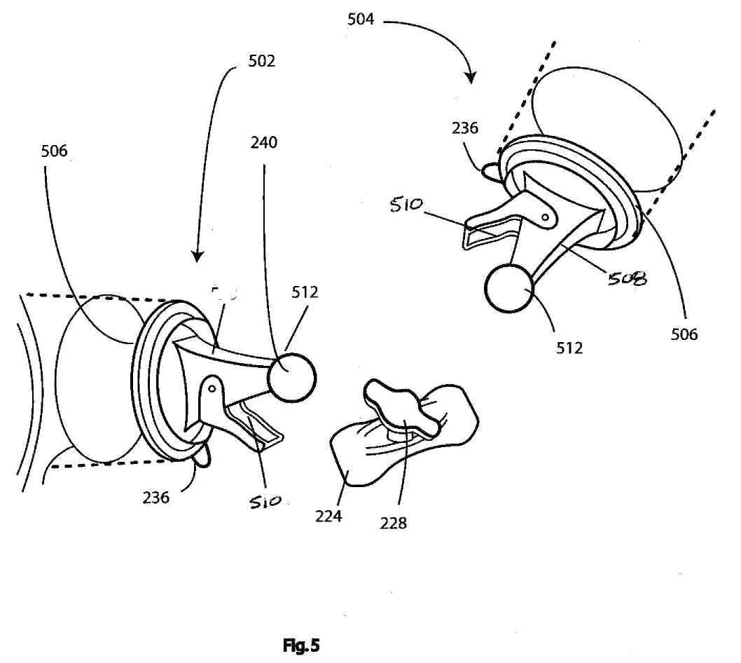

FIG. 5 depicts an alternate embodiment of the sheet holder 100 depicted in FIGS. 1-4. In the embodiment depicted in FIG. 5, the apparatus 500 is comprised of a first power-assisted suction device 502 coupled with a second power-assisted suction device 504 such that the suction membrane 506 of the first power-assisted suction device can be positioned and/or geometrically oriented relative to the suction membrane 506 of the second power-assisted suction device 504 in any desired position, configuration and/or geometric orientation.

In the embodiment depicted in FIG. 5, each of the power-assisted suction devices can be comprised of a suction membrane 506, a housing 508, an actuator 510 and a coupling 512. The suction membrane 506 is coupled with the housing 508 and is operationally coupled with the actuator 510. In operation, when the actuator 510 is transitioned from a first position to a second position, negative pressure is applied to the side of the suction membrane 506 proximal to the housing 508 causing the opposite side of the suction membrane 506 to create a vacuum and thus be attracted to a desired surface. In the embodiment depicted in FIG. 5, the coupling 512 can be a spherical ball coupled with the housing.

In the embodiment depicted in FIG. 5, the apparatus 500 comprises a configurable couple 514. In some embodiments the configurable couple 514 can be comprised of a pair of clamp shells 224 and 225 which define ball sockets capable of selectively engaging a coupling 512 at each end. In some embodiments, the pair of clamp shells 224 225 can simultaneously frictionally engage both couplings 512 via any known and/or convenient mechanism. In alternate embodiments, each end of the clamp shells 224 225 can be individually controlled to selectively engage each of couplings 512 in any known, convenient and/or desired manner. In some embodiments, at least a portion of the interior surface of at least one of the clamp shells 224 225 can include an elastomeric surface 238 having a desired coefficient of kinetic and/or static friction relative to one or more of the balls 222 226. In alternate embodiments, at least a portion of the exterior surface of one or more of the balls 222 226 can include an elastomeric surface 240 having a desired coefficient of kinetic and/or static friction relative to at least one of the interior surfaces of the at least one portion of one of the clamp shells 224 225.

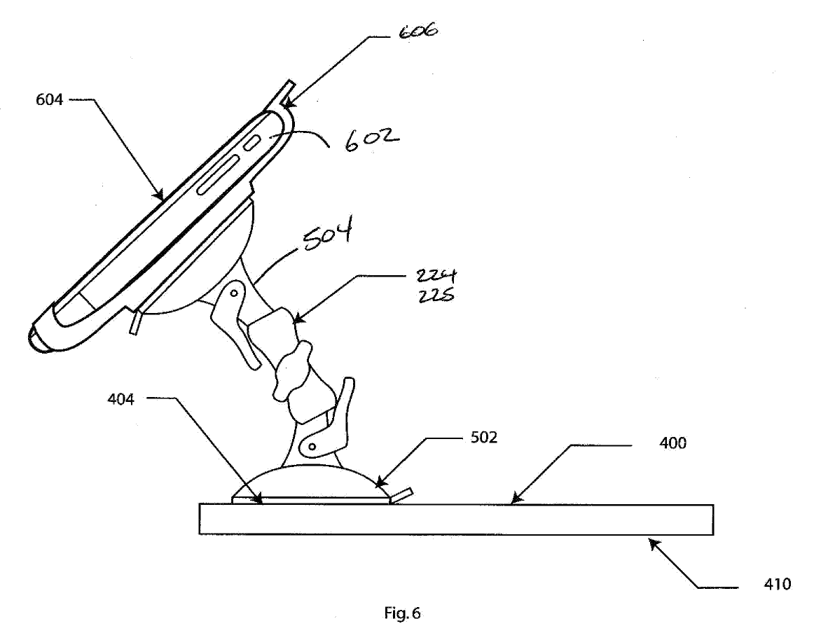

FIG. 6 depicts an embodiment of the apparatus 500 depicted in FIG. 5, in use. In the embodiment depicted in FIG. 6, the suction membrane 506 of the first power-assisted suction device 502 of apparatus 500 depicted in FIG. 5 is coupled with a guitar. In alternate embodiments, the suction membrane 506 can be coupled with any desired surface. In the embodiment depicted in FIG. 6, the suction membrane 506 of the second power-assisted suction device 504 of apparatus 500 is coupled with a device 602 including a display 604. In operation, the first and second power-assisted suction devices 502 504 and coupling 512 can be configured and semi-permanently fixed in a desired configuration such that a user can easily view the display 604 at a desired angle. In some embodiments, the device 602 can be selectively coupled with a retaining device 606 adapted to selectively engage and retain the device 602

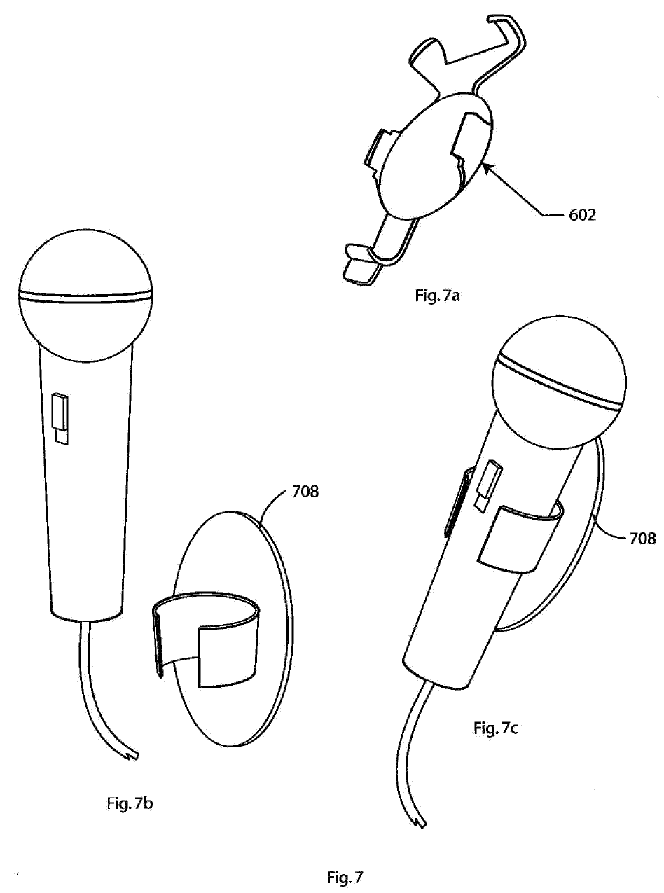

FIGS. 7a-7c depict alternate embodiments of the retaining device 606. In the embodiment depicted in FIG. 7a, the retaining device 606 includes a plurality of prongs 702 adapted to engage with a desired device. In some embodiments, at least one of the prongs 702 can include a prying mechanism 704 such that the device 606 can be deformed to facilitate the insertion and/or removal of an item. In some embodiments the retaining device 606 can include a suction panel 706. The suction panel can be adapted to selectively engage the power-assisted suction devices 502 504. In some embodiments it can be fabricated of the same material as the retaining device 606. However, in alternate embodiments it can be, at least in part, fabricated of a material designed to facilitate the vacuum attachment between the power-assisted suction device 502 504 and the retaining device 606.

FIGS. 7b and 7c depict alternate embodiments of the retaining device 606 depicted in FIG. 7a. In the embodiment depicted in FIGS. 7b and 7c, the retained item is depicted as a microphone. However, in alternate embodiment the retained item can be any known and/or desired object and/or item.

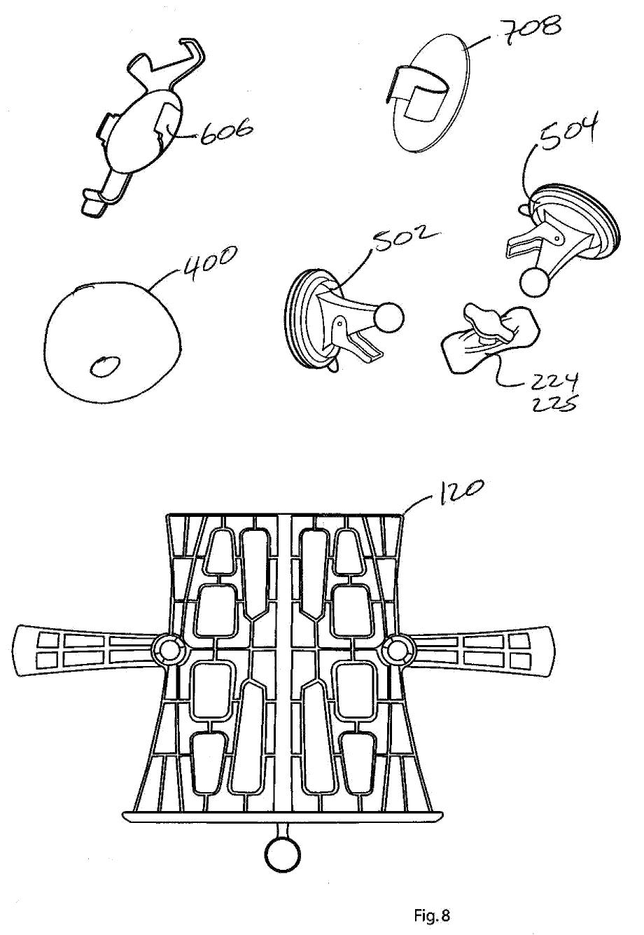

FIG. 8 depicts an embodiment of a kit comprising any desired number of components as outlined in this description. In some embodiments the kit can comprise a first power-assisted suction device 502, a second power-assisted suction device 504, a ball-clam mechanism 224 225, a retaining device 606 and a mounting board 400. However, in alternate embodiments, the kit can comprise any quantity of any of the elements described in this disclosure.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

What is claimed is:

1. A holder, comprising:
a first power-assisted suction device for selectively coupling with a first item;
a second power-assisted suction device for selectively coupling with a second item;
a clamp ball attached to each of the first and second power-assisted suction devices; and
a clamp;
wherein the clamp selectively engages each of the clamp balls and allows relative adjustment of the first power-assisted suction device and the second power-assisted suction device.
